(19) United States
(12) Patent Application Publication
(10) Pub. No.: US 2008/0271097 A1
(43) Pub. Date: Oct. 30, 2008

(54) System And Method For Receiving And Playing Network Television Programs

(75) Inventor: Yupeng Gao, Shenzhen Guandong (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED

(21) Appl. No.: 12/167,891

(22) Filed: Jul. 3, 2008

Related U.S. Application Data
(63) Continuation of application No. PCT/CN2007/000057, filed on Jan. 8, 2007.

(30) Foreign Application Priority Data
Jan. 6, 2006 (CN) 200610000228.6

(51) Int. Cl. H04N 7/173

(52) U.S. Cl. 725/100

(57) ABSTRACT

The present invention discloses a system and method for receiving and playing network television programs. The system of the present invention comprises a program receiving unit, adapted to receive video data of at least two programs and store the video data of the at least two programs in at least two caches respectively; and a program playing unit, adapted to provide at least two video windows and output the video data of the at least two programs respectively retrieved from the at least two caches onto the at least two video windows respectively. The method the present invention comprises receiving video data of at least two programs and storing the video data of the at least two programs in at least two caches respectively; and retrieving the video data of the at least two programs from the at least two caches respectively and outputting the video data onto the at least two video windows respectively. The technical scheme of the present invention enables a user to watch multiple television programs within one playback interface of a network television client terminal.

### CROSS-REFERENCE TO RELATED APPLICATIONS

This application is a CONTINUATION of International Application No. PCT/CN2007/000057, filed Jan. 8, 2007. This application claims the benefit of Chinese Patent Application No. 200610000228.6, filed Jan. 6, 2006. The disclosures of the above applications are incorporated herein by reference.

### FIELD

The present disclosure relates to Network Television techniques, and more particularly, to a system and method for receiving and playing network television programs.

### BACKGROUND

The statements in this section merely provide background information related to the present disclosure and may not constitute prior art.

Network Television is a new type of video service which transmits video streams over Internet and provides home users with a plurality of interactive services including Digital Television. To be more specific, Network Television can provide services of video-on-demand, broadcast/live broadcast, video phone call, short message/multimedia message, information service, game, etc. Network Television transmits television signals via telecommunication channels over a broadband network based on Internet Protocol such as the network of Asymmetric Digital Subscriber Line (ADSL), Ethernet or cable television; home television sets or computers are the major terminal devices for Network Television. In practical applications, Network Television technology is usually combined with Peer to Peer (P2P) technology and streaming media technology so as to provide a plurality of digital media services including television programs.

P2P represents a new network structure in a user broadband environment. Unlike the conventional Client/Server (C/S) structure, there may be no central server configured in a P2P structure, and alternatively, there may be a weak-functional central server configured in the P2P structure; the advantages of the P2P structure over the conventional C/S structure are that P2P structure can fully utilize the storage, CPU and bandwidth resources of users and that the operation and maintenance costs of the P2P structure are very low.

Streaming media technology, in short, is the utilization of streaming technology in the transmission of multimedia files over a network. Streaming technology is a type of network transmission technology, where data of consecutive video and audio information are compressed into video/audio files before the video/audio files are uploaded onto a website, which enables a user to watch or listen to the video/audio files while downloading the files without waiting for the completion of the download. Nowadays, P2P streaming media technology is usually adopted to obtain video and/or audio data of programs from at least one program sources. P2P streaming media technology provides live broadcast of streaming media by using the P2P technology, and typical applications of P2P streaming media technology include live broadcast of video and/or audio programs, IP-TV services, etc.; for instance, online live broadcasts of Olympic games, spring festival celebrations and talk shows are the applications of P2P streaming media technology.

In present Network Television, one client terminal of a Network Television can only receive signals of one program and can only present the one program at a time.

### SUMMARY

The present invention provides a system and method for receiving and playing network television programs so that a user may receive and watch a plurality of network television programs at the same time on one network television client terminal.

The system for receiving and playing network television programs in accordance with the present invention includes:

a program receiving unit, adapted to receive video data of at least two programs and store the video data of the at least two programs in at least two caches respectively; and

a program playing unit, adapted to provide at least two video windows and output the video data of the at least two programs respectively retrieved from the at least two caches onto the at least two video windows respectively.

The method for receiving and playing network television programs in accordance with the present invention comprises:

receiving video data of at least two programs and storing the video data of the at least two programs in at least two caches respectively; and

retrieving the video data of the at least two programs from the at least two caches respectively and outputting the video data onto the at least two video windows respectively.

The system and method for receiving and playing network television programs in accordance with the present invention enable one network television client terminal to receive video signals of multiple programs at the same time, therefore a user may watch a plurality of programs on one network television client terminal at the same time and the user experience is thus improved.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

The present invention is hereinafter further described in detail with reference to the accompanying drawings and embodiments. It should be noted that the following description is only illustrative examples of the present invention and is not for use in limiting the protection scope of the present invention. The accompanying drawings are described as follows:

FIG. 1 is a schematic diagram illustrating the structure of a system for receiving and playing network television programs in accordance with an embodiment of the present invention; and

FIG. 2 is a schematic flow chart illustrating a method for receiving and playing network television programs in accordance with an embodiment of the present invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

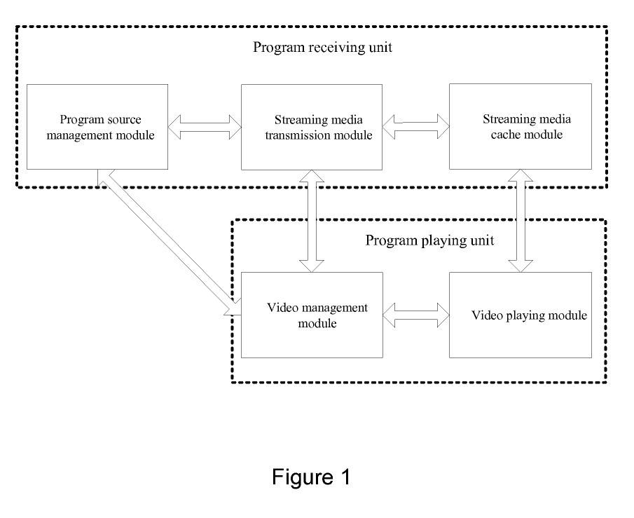

FIG. 1 shows a system for receiving and playing network television programs in accordance with an embodiment of the present invention, the system includes a program receiving unit and a program playing unit.

The program receiving unit receives video data of multiple programs at the same time and stores the video data into caches of the programs respectively; the program playing unit provides a plurality of video windows, and retrieves the video data from the caches of different programs and outputs the video data onto different video windows to play simultaneously.

The program receiving unit includes a program source management module, a streaming media transmission module and a streaming media cache module.

The program source management module parses a command from a user to obtain program source information of the multiple programs wanted by the user. To be specific, the module manages updating and switching of all program sources and synchronizes the program sources. The streaming media transmission module sets up streaming media transmission channels for different programs based on the program source information of the programs from the program source management module. To be specific, the module responds to the control of the program source management module, acquires the video data of the multiple programs from specified program sources and transmits the video data to a local machine by using P2P transmission mechanism. The streaming media cache module stores the video data received synchronously via a plurality of streaming media transmission channels in the caches corresponding to the channels respectively. To be specific, the module manages the caching of the video data of the multiple programs on the local machine and cooperates with a video playing module in playing the video data on the local machine.

The program playing unit includes a video management module and a video playing module.

The video management module provides a plurality of video windows, the number of which is identical to the number of caches, for the video playing module according to preset attributes and layouts and controls the video playing module to play the video data on the video windows. To be specific, the module manages retrieving video data for the video windows, manages the layout of the user interaction elements and manages switching and adjustment of primary/secondary windows. The video playing module retrieves, under the control of the video management module, video data from the different caches corresponding to the different video windows and outputs the video data onto the video windows at the same time. To be specific, the module plays the video data of the multiple received programs.

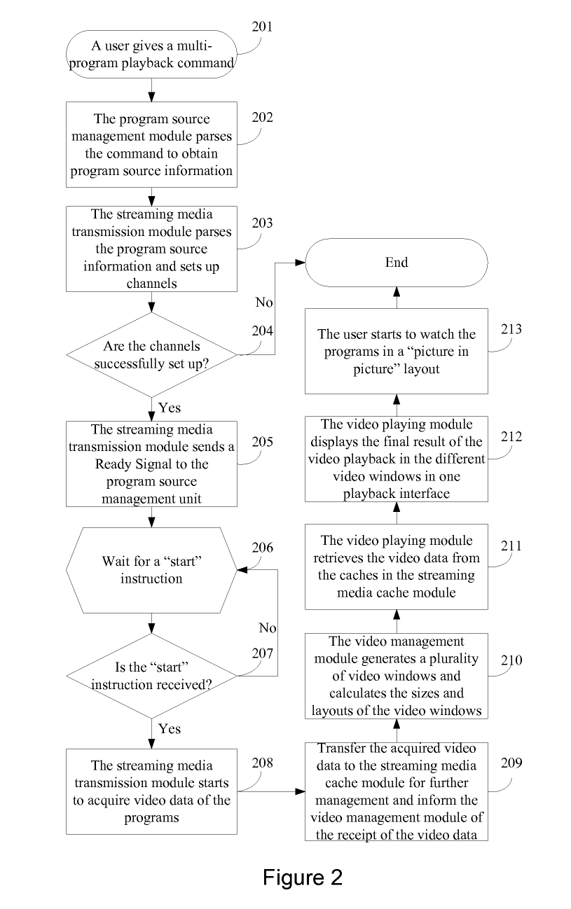

FIG. 2 shows a method for receiving and playing network television programs in accordance with an embodiment of the present invention. The operation flow provided by the method enables a network television client terminal to receive multiple programs at the same time and to play the multiple programs on the network television playback interface at the same time, so that a user may watch the multiple programs at the same time. It should be noted that the programs comprise a plurality of digital media services including television programs.

In Step 201, the system receives a multi-program playback command from the user via an interaction interface and thus needs to receive and play multiple programs on one playback interface at the same time, e.g., in a “picture in picture” layout. In this embodiment, the user may choose to play one program on multiple video windows.

In Step 202, the system transmits the command to the program source management module. The program source management module parses the command and obtains program source information corresponding to each one of two or more programs wanted by the user, the program source information of a program includes a channel identifier (ID) as well as other relevant information of the program source. In this embodiment, the multiple programs may come from a same program source, i.e., a same channel.

In Step 203, the program source management module sends the obtained program source information to the streaming media transmission module and notifies the streaming media transmission module to set up streaming media transmission channels over which the video data can be received through P2P network.

In Steps 204-205, the streaming media transmission module, according to a control command from the program source management module, sets up and prepares a plurality of streaming media transmission channels in accordance with the communication protocol and sends a Ready Signal to the program source management module. One streaming media channel is connected only to the program source of one program wanted by the user, i.e., the plurality of streaming media transmission channels correspond to the multiple programs respectively.

In Steps 206-207, the program source management module, upon receipt of the Ready Signal, sends an instruction to the streaming media transmission module, instructing the streaming media transmission module to acquire the video data.

In Step 208, the streaming media transmission module launches the readily prepared streaming media transmission channels in a manner that the channels receive the video data of corresponding programs simultaneously and separately.

In Step 209, when the streaming media transmission module has acquired the video data of the multiple programs, the streaming media transmission module sends a message to the video management module via the program source management module to inform of the receipt of the video data, and transfers the video data of the programs to the streaming media cache module for further management. The streaming media cache module stores the video data of the different programs in different caches, e.g., stores the video data acquired over the first streaming media channel in the first cache, and stores the video data acquired over the second streaming media channel in the second cache, etc.

In Step 210, upon receipt of the message which informs of the receipt of the data video, the video management module parses the message and generates or updates a plurality of video windows, and calculates the attributes of the video windows, including the sizes, layouts and video qualities of the video windows.

In Step 211, the video management module sends preset storage parameters of the video data to the video playing module in a video data storage message, the video playing module parses the received video data storage message and retrieves the video contents of the programs from the caches in the streaming media cache module according to the parsed storage parameters.

In Step 212, the video playing module sends the video contents of different programs, according to the preset corresponding relations between the caches and the video windows, to different video windows in the playback interface of the network television client terminal in a manner that the programs are played at the same time. The preset corresponding relations between the caches and the video windows can be interpreted that, for example, the video content from the first cache is played in the first video window, and the video content from the second cache is played in the second video window, etc.

In Step 213, the user watches the programs specified in the multi-program playback command given by the user himself and the playback effect of video contents in the video windows, e.g., a “picture in picture” effect, gives the user a feeling of watch a plurality of programs in one playback interface.

Obviously, those skilled in the art may make numerous changes and variations on the technical scheme of the present invention without departing from the spirit and scope thereof. Accordingly, it is intended that the present invention includes the changes and variations in case that such changes and variations come within the scope as set forth in the appended claims and the equivalent techniques thereof.

What is claimed is:

1. A system for receiving and playing network television programs, comprising:
a program receiving unit, adapted to receive video data of at least two programs and store the video data of the at least two programs in at least two caches respectively; and
a program playing unit, adapted to provide at least two video windows and output the video data of the at least two programs respectively retrieved from the at least two caches onto the at least two video windows respectively.

2. The system according to claim 1, wherein the program receiving unit comprises:
a program source management module, adapted to parse a command from a user to obtain program source information of the at least two programs;
a streaming media transmission module, adapted to set up at least two streaming media transmission channels for the at least two programs based on the program source information of the at least two programs from the program source management module; and
a streaming media cache module, adapted to store the video data of the at least two programs respectively received via the at least two streaming media transmission channels in the at least two caches respectively.

3. The system according to claim 2, wherein the program source information comprises a channel identifier.

4. The system according to claim 1, wherein the program playing unit comprises:
a video management module, adapted to provide the at least two video windows and control a video playing module to play the video data in the at least two video windows; and
the video playing module, adapted to retrieve, under the control of the video management module, the video data of the at least two programs respectively from the at least two caches and play the video data respectively in the at least two video windows.

5. A method for receiving and playing network television programs, comprising:
receiving video data of at least two programs and storing the video data of the at least two programs in at least two caches respectively; and
retrieving the video data of the at least two programs from the at least two caches respectively and outputting the video data onto the at least two video windows respectively.

6. The method according to claim 5, wherein receiving video data of at least two programs and storing the video data of the at least two programs in at least two caches respectively comprise:
parsing a command from a user to obtain program source information of the at least two programs;
setting up at least two streaming media transmission channels for the at least two programs based on the program source information of the at least two programs; and
receiving the video data of the at least two programs respectively via the at least two streaming media transmission channels and storing the received video data in the at least two caches respectively.

7. The method according to claim 6, wherein the program source information comprises a channel identifier.

8. The method according to claim 5, wherein retrieving the video data of the at least two programs from the at least two caches respectively and outputting the video data onto the at least two video windows respectively comprise:
providing the at least two video windows; and
retrieving the video data of the at least two programs respectively from the at least two caches and playing the video data respectively in the at least two video windows.

9. The method according to claim 8, comprising providing the at least two video windows according to preset window attributes.

10. The method according to claim 9, wherein the preset window attributes comprises sizes, layouts and video qualities of the video windows.
